(19) United States
(12) Patent Application Publication
(10) Pub. No.: US 2024/0396249 A1
(43) Pub. Date: Nov. 28, 2024

(54) SEALED CONNECTOR WITH A PRIMARY LOCK REINFORCEMENT DEVICE HAVING TERMINAL UNLOCKING MEANS

(71) Applicant: Aptiv Technologies AG, Schaffhausen (CH)

(72) Inventors: Nithish SUKUMAR, Karur (IN); Mirko Posmik, Fürth (DE)

(21) Appl. No.: 18/672,451

(22) Filed: May 23, 2024

(30) Foreign Application Priority Data
May 23, 2023 (EP) 23174976.3

(51) Int. Cl. H01R 13/436; H01R 13/502; H01R 13/52; H01R 43/20

(52) U.S. Cl. CPC H01R 13/4365; H01R 13/502; H01R 13/5202; H01R 43/20

(57) ABSTRACT

An electrical connector is disclosed, including an inner housing with multiple cavities, an outer housing accommodating the inner housing, two terminals housed in the cavities, and a primary lock reinforcement device (PLR). The PLR is mounted on the inner housing and can be moved parallel to the longitudinal direction between three positions: a locking position where the PLR is covered by the outer housing and provides secondary locking means, an intermediate position where the terminals are locked in their final positions, and an unlocking position where the terminals are released. This design allows for secure locking of terminals within the connector while providing ease of unlocking for maintenance or replacement purposes.

### CROSS-REFERENCE TO RELATED APPLICATION

This application claims the benefit of and priority to European Patent Application No. 23174976.3 titled “Scaled Connector with a PLR Having Terminal Unlocking Means” filed on May 23, 2023, the contents of which are incorporated by reference herein.

### TECHNICAL FIELD

This disclosure generally relates to the field of automotive interconnections. More particularly, this disclosure relates to a sealed connector. For example, this disclosure relates to a sealed cable connector for high-speed signal transmission.

### BACKGROUND

Primary lock reinforcement devices are commonly used in connectors. “Primary Lock Reinforcement” devices are commonly named “PLR”. In this document, we use this acronym. PLR may also be used as terminal position assurance devices. Terminal position assurance devices are used in connectors to ensure that terminals are properly, completely, and functionally accommodated in their respective housing cavities. Terminal position assurance devices are commonly named “TPA”. One knows connectors having a housing with an outer wall and a PLR inserted through a window formed in the outer wall. However, such a configuration may not be compatible with certain sealing requirements.

Previous approaches to electrical connectors have typically involved designs with fixed locking mechanisms that secure terminals in place within the connector. These fixed locking mechanisms often require disassembly of the connector to release the terminals, making maintenance and repair cumbersome and time-consuming. Additionally, fixed locking mechanisms may not provide the flexibility needed for certain applications where terminals need to be easily accessible or replaced without extensive effort.

Some existing electrical connectors have attempted to address the limitations of fixed locking mechanisms by incorporating movable locking devices. These movable locking devices allow for terminals to be released without disassembly of the connector, providing a more user-friendly solution for maintenance and repair. However, these designs often lack the ability to securely lock the terminals in place, leading to potential issues with stability and reliability of the electrical connection.

Other prior art electrical connectors have utilized secondary locking means to enhance the security of the connection between terminals and the connector housing. While these secondary locking means have improved the overall stability of the electrical connection, they have not fully addressed the need for a versatile locking mechanism that allows for easy access to terminals while maintaining a secure connection. Additionally, existing designs may not provide a clear indication of the locking status of the terminals, leading to potential errors during installation or maintenance procedures.

However, none of these approaches have provided a comprehensive solution that combines the features described in this disclosure.

### SUMMARY

In some aspects, the techniques described herein relate to an electrical connector, including: an inner housing including at least two cavities extending parallel to a longitudinal direction; an outer housing including a mating face and being configured to accommodate the inner housing at least partially; at least two terminals, each one of which being accommodated in one of the at least two cavities; and a primary lock reinforcement device (PLR), wherein the PLR is mounted on the inner housing and is configured to be moved, between the inner and outer housings, parallel to the longitudinal direction, between at least three positions: a locking position where the PLR is completely covered by the outer housing, where a front scaling portion open on the mating face of the outer housing is cleared from the inner housing and the PLR, and where the PLR provides a secondary locking means blocking primary locking means that locks each one of the at least two terminals, in a final position in its respective cavity, an intermediate position in which each one of the at least two terminals is locked by the primary locking means in the final position in its respective cavity, and an unlocking position where each one of the at least two terminals is released from the primary locking means.

In some aspects, the techniques described herein relate to a method of assembling an electrical connector, including: providing an inner housing, an outer housing, at least two terminals, and a PLR; positioning the PLR onto the inner housing; inserting in the outer housing, the inner housing with the PLR positioned onto it, up to a locked position where the inner housing is locked to the outer housing; inserting each terminal in the inner housing, up to a final position, where it is locked in the inner housing by primary locking means formed on the inner housing; and moving the PLR from an unlocking position, where it does not block the primary locking means, to a locking position, where it blocks the primary locking means and where a front sealing portion open on a mating side of the outer housing is cleared from the inner housing and the PLR.

In some aspects, the techniques described herein relate to a method of removing a terminal from a connector having an inner housing including at least two cavities extending parallel to a longitudinal direction, an outer housing including a mating face and being configured to at least partially accommodate the inner housing, at least two terminals, each one of which being accommodated in one of the at least two cavities, and a primary lock reinforcement device (PLR), wherein the PLR is mounted on the inner housing and is configured to be moved, between the inner and outer housings, parallel to the longitudinal direction, between at least three positions: a locking position where the PLR is completely covered by the outer housing, where a front sealing portion open on the mating face of the outer housing is cleared from the inner housing and the PLR, and where the PLR provides a secondary locking means blocking primary locking means that locks each one of the at least two terminals, in a final position in its respective cavity, an intermediate position in which each one of the at least two terminals is locked by the primary locking means in the final position in its respective cavity, and an unlocking position where each one of the at least two terminals is released from the primary locking means, wherein the method includes: hooking the PLR with a tool and pulling the tool so as to move the PLR from its locking position and its unlocking position, thereby releasing each terminal.

### BRIEF DESCRIPTION OF THE DRAWINGS

The present invention is now described, by way of example with reference to the accompanying drawings, in which:

FIG. 1 is a schematic perspective view of a connector according to some embodiments.

FIG. 2 is a schematic exploded view of the connector illustrated in FIG. 1 according to some embodiments.

FIG. 3 is a schematic perspective view of the connector illustrated in FIGS. 1 and 2 without its outer housing, its cables, and its terminals according to some embodiments.

FIG. 4 is a schematic longitudinal and vertical cross-sectional view of the outer housing, PLR and inner housing of the connector illustrated in FIGS. 1 and 2, the inner housing being partially inserted in the outer housing according to some embodiments.

FIG. 5 is a schematic cross-sectional view similar to FIG. 4, the inner housing being fully inserted and locked in the outer housing according to some embodiments.

FIG. 6 is a schematic longitudinal and horizontal cross-sectional view of the outer housing, PLR and inner housing of the connector illustrated in FIGS. 1 and 2, with the terminals partially inserted in a rear sealing portion of the outer housing, and with the PLR in the intermediate position according to some embodiments.

FIG. 7 is a schematic cross-sectional view similar to FIG. 6, with each terminal fully inserted in its respective cavity according to some embodiments.

FIG. 8 is a schematic elevation view from above of the connector illustrated in FIGS. 1 and 2, without its outer housing, and with the PLR in locking position according to some embodiments.

FIG. 9 is a schematic elevation view similar to FIG. 8, with the PLR in intermediate position according to some embodiments.

FIG. 10 is a schematic longitudinal and vertical cross-sectional view of a detail showing more particularly the primary and secondary locking means of the connector illustrated in FIGS. 1 and 2 according to some embodiments.

FIG. 11 is a schematic perspective view of an example embodiment of a tool configured to actuate the PLR of the connector illustrated in FIGS. 1 and 2 according to some embodiments.

FIG. 12 is a schematic partial cross-sectional view similar to FIGS. 4 and 5, showing the PLR in locking position according to some embodiments.

FIG. 13 is a schematic partial cross-sectional view similar to FIG. 12, showing the PLR in intermediate position according to some embodiments.

FIG. 14 is a schematic lateral elevation view of the connector illustrated in FIGS. 1 and 2, without its outer housing, and showing the PLR in intermediate position according to some embodiments.

FIG. 15 is a schematic partial, longitudinal and vertical cross-sectional view of the connector illustrated in FIGS. 1 and 2, without its outer housing, showing the PLR in unlocking position according to some embodiments.

FIG. 16 is a schematic cross-sectional view similar to FIG. 15, showing the PLR in intermediate position and a terminal partially removed from its cavity according to some embodiments.

FIG. 17 is a lateral elevation view similar to FIG. 14, showing the PLR in unlocking position and a terminal completely removed from its cavity according to some embodiments.

### DETAILED DESCRIPTION

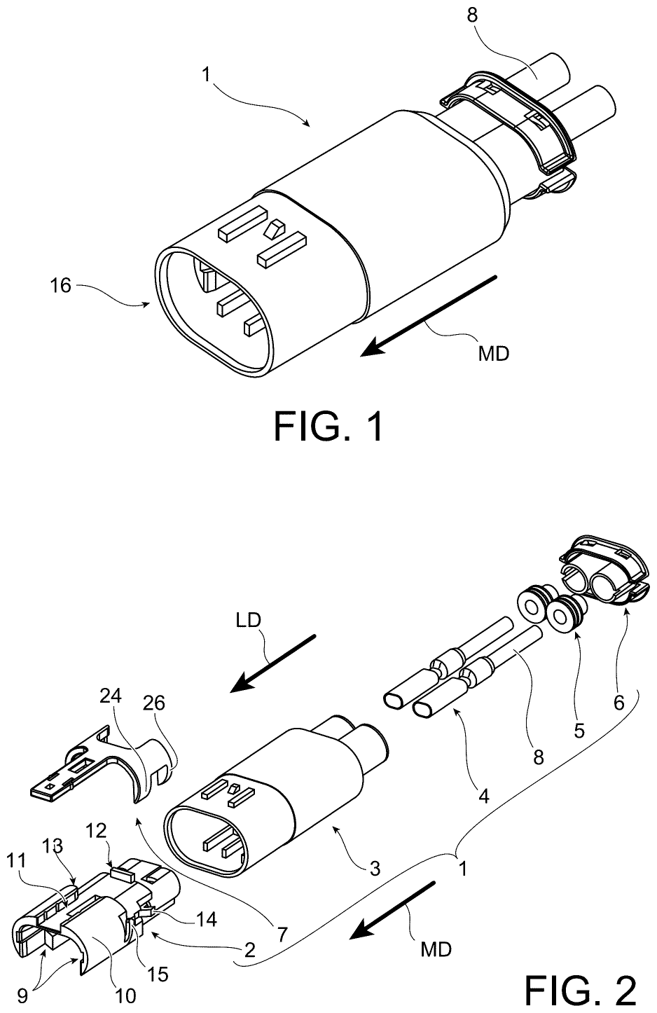

FIG. 1 shows an embodiment example of an electrical sealed connector 1. According to this example, the connector 1 is a H-MTD® connector (“H-MTD” stands for High-Speed Modular Twisted-Pair Data). More particularly, according to this example, the connector 1 is a two-way cable connector, i.e., it contains two electrical terminals. In this example, it is a male connector. The connector 1 is configured and intended to be connected in a mating direction MD to a counter-connector (in this example, a female connector which is not shown).

FIG. 2 is an exploded view of the connector illustrated in FIG. 1. This electrical connector 1 includes an inner housing 2, an outer housing 3, a pair of male terminals 4, a pair of single-wire seals 5, a retainer 6 and a PLR 7. The male terminals 4 of H-MTD® connectors are particularly long. It is therefore difficult to use conventional PLR designs. Further, conventional PLRs are not easily adapted for use with automated assembly processes. The PLR 7 disclosed here-below mitigates these drawbacks.

The inner housing 2, the outer housing 3, the retainer 6 and the PLR 7 are made of molded plastics. Each terminal 4 is crimped at the free end of a respective electrical cable 8. Each terminal 4 is made of an electrically conductive material.

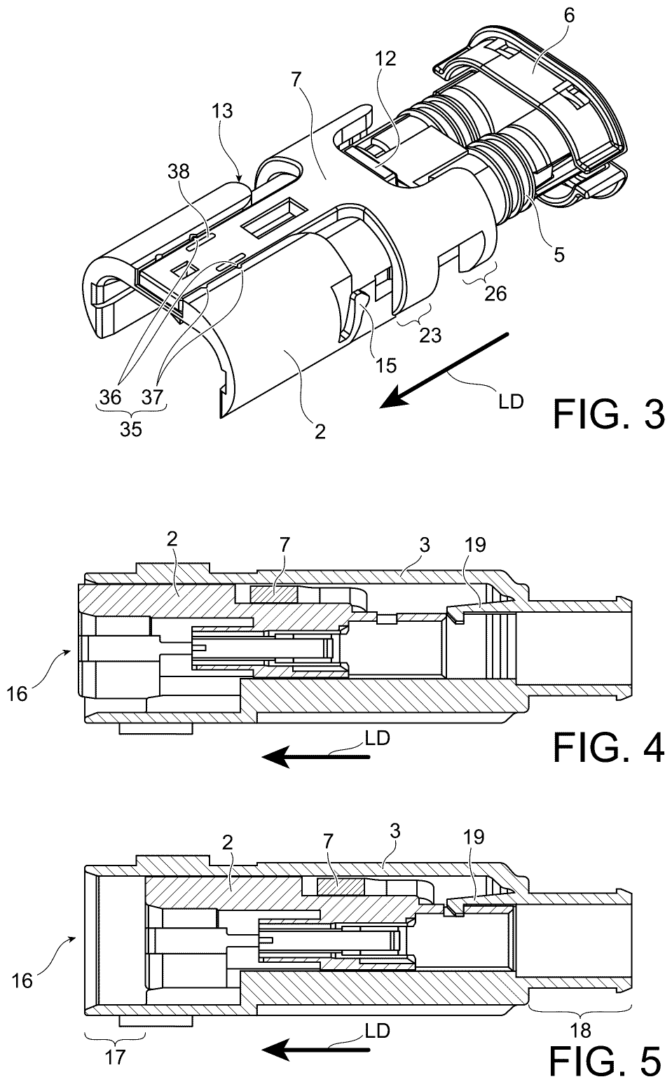

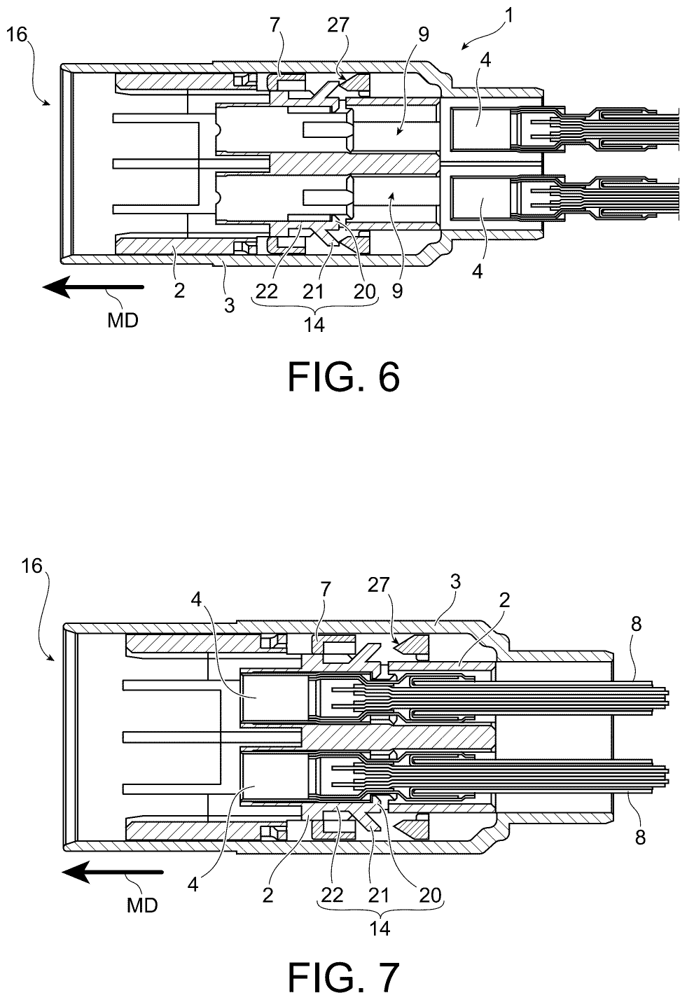

The inner housing 2 includes two cavities 9 extending parallel to a longitudinal direction LD. In the illustrated example, the connector 1 is a straight connector and this longitudinal direction LD is parallel to a mating direction MD (See FIGS. 6 and 7). The mating direction MD is the direction in which the connector 1 is mated and connected to a counter-connector. Each terminal 4 is respectively accommodated in one of the two cavities 9. The inner housing 2 includes an external surface 10 within which a channel 11 is formed (See FIGS. 2 and 3). The inner housing 2 further includes a first stop 12, a second stop 13, primary locking means 14, spring means 15, the functions of which are disclosed below (See FIGS. 2 and 3).

The outer housing 3 includes a mating face 16 (See FIGS. 1, 4 to 7, 12 and 13). The outer housing 3 accommodates the inner housing 2. For example, the inner housing 2 is completely inserted in the outer housing 3 (See FIG. 5). For example, the inner housing 2 is inserted in the outer housing 3 from its mating face 16 (i.e. its front face). When the inner housing 2 is fully (completely) inserted in the outer housing 3, a front sealing portion 17, open on the mating face 16 of the outer housing 3, is cleared from the inner housing 2. In other words, the front sealing portion 17 is configured to form a sealing barrier with a counter-connector mated to the connector 1. The outer housing 3 has a rear scaling portion 18 configured to accommodate the single-wire seals 5. The rear scaling portion 18 is configured to form a sealing barrier with each cable 8. Therefore, when the inner housing 2 is accommodated in the outer housing 3, when the connector 1 is mated to a counter-connector and when the cables 8 and the seals 5 are mounted in the connector 1, the connector 1 is sealed (in particular against water and dust).

The outer housing 3 has a resilient locking lance 19 configured to lock the inner housing 2 in the outer housing 3, when the inner housing 2 is fully inserted in the outer housing 3 (See FIG. 5).

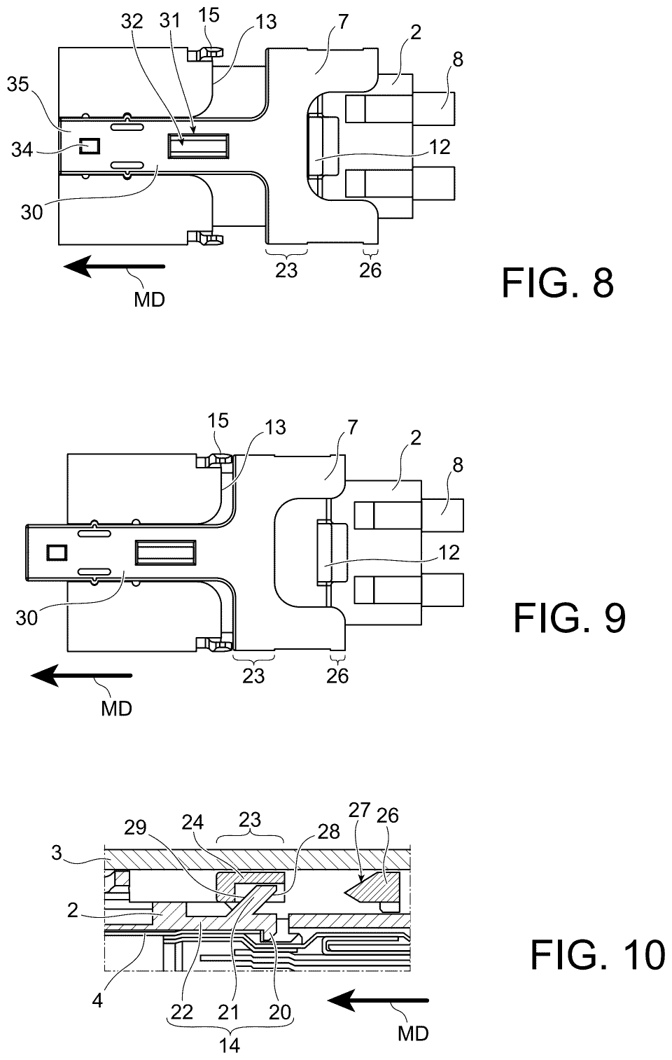

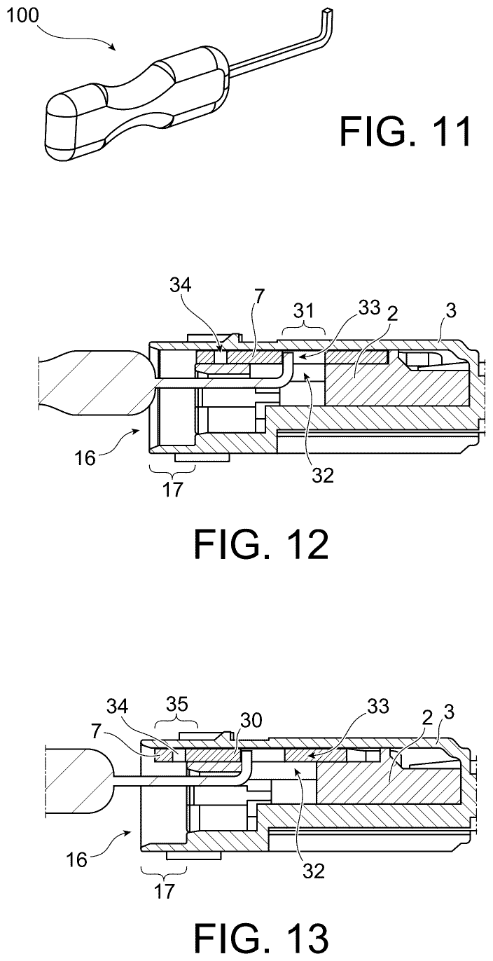

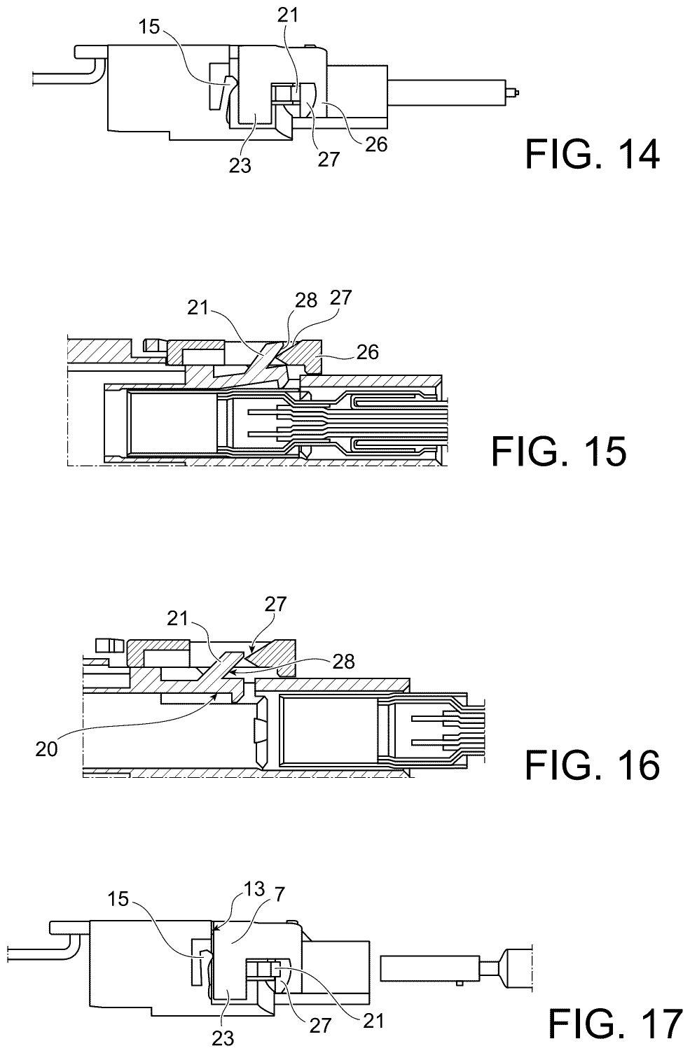

The PLR 7 is mounted on the inner housing 2. The PLR 7 is movable, between the inner housing 2 and outer housing 3, parallel to the longitudinal direction LD. In particular, when moving the PLR 7 parallel to the longitudinal direction LD, three positions can be identified along the corresponding path of PLR 7: a locking position (See FIGS. 3, 8, 10 and 12), an unlocking position (See FIGS. 15 and 17) and an intermediate position (See FIGS. 4 to 7, 9, 13, 14 and 16). The locking position and unlocking position correspond to the two ends of this path. The intermediate position is between the locking position and unlocking position. When the PLR 7 is pushed in a direction from the front sealing portion 17 towards the rear scaling portion 18 (i.e. backwards), it is blocked by the first stop 12, in the locking position (See FIG. 8). When the PLR 7 is pushed in a direction from the rear sealing portion 18 towards the front sealing portion 17 (i.e. frontwards), it presses the spring means 15, until it abuts against the second stop 13, in the unlocking position (See FIG. 17). The PLR 7 is placed in the intermediate position for inserting the terminals 4 in their respective cavities 9 (See FIGS. 6 and 7).

In the locking position, the front sealing portion 17 is cleared from the inner housing 2 and from the PLR 7, so that the connector 1 can be mated to the counter-connector. In the locking position, the inner housing 2 and the PLR 7 are both located behind the front scaling portion 17, with respect to the direction from the front scaling portion 17 to the rear scaling portion 18 (See FIG. 12). On the contrary, in the unlocking position and in the intermediate position, the PLR 7 partially protrudes in the front sealing portion 17 and thereby prevents the connector 1 from being connected to the counter-connector (See FIG. 13, for example).

The primary locking means 14 includes two latches 20, two lugs 21 and two flexible branches 22 (See FIG. 10). For example, each flexible branch 22 extends backwards from the inner housing 2 towards one latch 20 and one lug 21. For example, each flexible branch 22 is located on one side of a cavity 9 (See FIGS. 6 and 7). Each latch 20 extends inwardly relatively to the corresponding cavity 9, protrudes inside this cavity 9 and is configured so as to lock one terminal 4 accommodated in this cavity 9. More particularly, a latch 20 locks a terminal 4, only when this terminal 4 is fully inserted in its cavity 9 in a final and functional position. If a terminal 4 is not properly inserted in its cavity 9, the latch 20 rests on the corresponding terminal 4.

Each lug 21 extends from a flexible branch 22, outwardly relatively to the corresponding cavity 9. Each lug 21 extends and protrudes in the pathway of the PLR 7. Therefore, when the latch 20 rests on the corresponding terminal 4, the corresponding lug 21 prevents the PLR 7 from being moved to the locking position. But, when a latch 20 locks a terminal 4, the corresponding lug 21 is retracted enough to allow the PLR 7 to move from the unlocking position, or intermediate position, to the locking position. In the intermediate position of the PLR 7, each terminal 4 in a final position is locked, in its respective cavity 4, by the primary locking means including the latch 20. When the PLR 7 is in the locking position, it plays the role of a secondary locking means. Indeed, in the locking position, a locking section 23 of the PLR 7 covers the latch 20 and the lug 21 and prevents the flexible branches 22 from lifting (See FIGS. 3, 8 and 10). In other words, in the locking position, the PLR 7 blocks the outward movement of each lug 21 (See FIG. 10). For example, the locking section 23 has two locking wings 24, each one of which covering a latch 20 and a lug 21.

The PLR 7 also has an unlocking section including two unlocking wings 26. Each one of these two unlocking wings 26 bears one unlocking surfaces 27.

Each lug 21 has a first slanted surface 28 and a second slanted surface 29 (See FIG. 10). The first slanted surface 28 of each lug 21 is configured to engage the unlocking surface 27 of the PLR 7, when the PLR 7 is moved from the locking position to the unlocking position. In particular, when the PLR 7 is moved from the intermediate position and the unlocking position, each unlocking surface 27 lifts the corresponding branch 22, thereby releasing the corresponding terminal 4 from the corresponding latch 20. In other words, in the unlocking position of the PLR 7, each terminal 4 is released from the primary locking means. On the contrary, each second slanted surface 29 is configured so as not to block the movement of the PLR 7 towards the locking position. In other words, if the PLR were to touch this second slanted surface 29, the latter is oriented so that the PLR 7 slides over it.

The PLR 7 has an actuating leg 30 (See FIGS. 8 and 9). When the PLR 7 is mounted in the connector 1, the actuating leg 30 extends longitudinally from the locking section 23 toward the mating face 16 (i.e. in the mating direction MD). This actuating leg 30 is configured to be accessible from the mating face 16 (See FIG. 12). The actuating leg 30 includes a first hooking portion 31 configured to actuate the PLR 7 from the intermediate position to the locking position and vice-versa. Indeed, the inner housing 2 has a window 32 and the first hooking portion 31 has a slot 33. A tool 100 can be used to penetrate both the window 32 and the slot 33. Once the tool 100 engages the slot 33, an operator can pull the tool 100, thereby moving the PLR 7 from the locking position toward the unlocking position, to place the PLR 7 in the intermediate position. In the intermediate position, the tool 100 is blocked by an edge of the window 32 (See FIG. 13). Then, the tool 100 is removed from the slot 33 and is possibly inserted in a notch 34 of a second hooking portion 35 of the actuating leg 30. Once the tool 100 engages the notch 34, an operator can pull the tool 100, thereby moving the PLR 7 from the intermediate position toward the unlocking position, to place the PLR 7 in the unlocking position. From the intermediate position to the unlocking position, the locking section 23 presses the spring means 15 and the unlocking surfaces 27 engage the first slanted surfaces 28 to lift the branches 22 (See FIGS. 15 and 17). As a result, to lift the latches 20, the terminals 4 are released. When the tool 100 is removed from the notch 34, the spring means 15 returns the PLR 7 to the intermediate position.

Indexing means 35 may be used to help an operator to position the PLR 7 (see FIG. 3). For example, the indexing means 35 include a rib 36 on both lateral sides of the actuating leg 30 and two grooves 37 in the channel 11. The grooves 37 are positioned along the PLR path so as to index the locking position and the intermediate position. Each rib 36 is born by a flexible bridge 38. For assembling the connector 1, at least the following steps are performed:
positioning the PLR 7 onto the inner housing;
inserting in the outer housing 3, the inner housing 2 with the PLR 7 positioned onto it, up to a locked position where the inner housing 2 is locked to the outer housing 3 (for example with the locking lance 19);
inserting each terminal 4 in a respective cavity 9 of the inner housing 2, up to a final position, where it is locked in the inner housing 2 by primary locking means 14 formed on the inner housing 2 (i.e. the latches 20); and
moving the PLR 7 from an unlocking position or an intermediate position, where it does not block the primary locking means 14, to a locking position, where each locking wing 24 prevents the respective lug 21 to lift, prevents the respective latch 20 to escape from the corresponding cavity 9 and consequently prevents the respective terminal 4 from being removed from its cavity 9 if pulled back towards the rear sealing portion 18.

For removing the terminals 4 from the connector 1, the PLR 7 is moved from the locking position to the unlocking position, with a tool 100. Possibly the PLR 7 is moved from the locking position to the unlocking position in two steps: a) from the locking position to the intermediate position, with the tool 100 inserted in the first hooking section 23 (i.e. the slot 33), and b) from the intermediate position to the unlocking position, with the tool 100 inserted in the second hooking section (i.e. the notch 34). Thereby, the unlocking surfaces 27 lift the lugs 21 and release the terminals 4 from the latches 20.

The connector 1 and the assembling method have several advantages. For example,
the use of a tool 100 inserted in the inner 2 and outer 3 housings allows for a reduced length of the connector 1;
the actuating leg 30 partially protruding in the front scaling portion 17 prevents a counter-connector to be mated to the connector 1 if the terminals 4 are not well positioned in their respective cavities 9; an incorrect insertion of the terminals 4 can be easily detected by an automation actuator due to the low drive load and the possibility to predict the resistive force;
the self-locking of the PLR 7 thanks to the locking lance 19 makes the connector 1 automation friendly (no separate PLR actuator is required); and
the PLR 7 can easily be opened and closed without moving the housing parts 2, 3 during while replacing the terminals 4.

### Discussion of Possible Embodiments

The following are non-exclusive descriptions of possible embodiments.

In some aspects, the techniques described herein relate to an electrical connector, including: an inner housing including at least two cavities extending parallel to a longitudinal direction; an outer housing including a mating face and being configured to accommodate the inner housing at least partially, at least two terminals, each one of which being accommodated in one of the at least two cavities, and a primary lock reinforcement device (PLR), wherein the PLR is mounted on the inner housing and is configured to be moved, between the inner and outer housings, parallel to the longitudinal direction, between at least three positions: a locking position where the PLR is completely covered by the outer housing, where a front scaling portion open on the mating face of the outer housing is cleared from the inner housing and the PLR, and where the PLR provides a secondary locking means blocking primary locking means that locks each one of the at least two terminals, in a final position in its respective cavity, an intermediate position in which each one of the at least two terminals is locked by the primary locking means in the final position in its respective cavity, and an unlocking position where each one of the at least two terminals is released from the primary locking means.

The electrical connector of the preceding paragraph can optionally include, additionally and/or alternatively any, one or more of the following features, configurations and/or additional components.

In some aspects, the techniques described herein relate to an electrical connector, wherein the inner housing has at least two latches, each one of these two latches being configured to form the primary locking means.

In some aspects, the techniques described herein relate to an electrical connector, wherein the PLR includes at least two unlocking surfaces, each one of these two unlocking surfaces being configured to lift one of the at least two latches, when the PLR is moved from its locking position and to its unlocking position.

In some aspects, the techniques described herein relate to an electrical connector, wherein the PLR has an unlocking section including at least two unlocking wings, each one of these two unlocking wings bearing one of the at least two unlocking surfaces.

In some aspects, the techniques described herein relate to an electrical connector, wherein the PLR has an actuating leg extending longitudinally from a locking section toward the mating face, this actuating leg being configured to be accessible from the mating face.

In some aspects, the techniques described herein relate to an electrical connector, wherein the outer housing includes the front sealing portion and a rear sealing portion, the outer housing being completely closed between the front sealing portion and the rear scaling portion, the inner housing and the PLR being both located behind the front sealing portion, with respect to the direction from the front sealing portion to the rear sealing portion, when the PLR is in its locking position.

In some aspects, the techniques described herein relate to a connector, wherein the PLR includes a first hooking portion configured for actuating the PLR from the intermediate position to the locking position and vice-versa.

In some aspects, the techniques described herein relate to a connector, wherein the PLR includes a second hooking portion configured for actuating the PLR from an intermediate position to its unlocking position and vice-versa.

In some aspects, the techniques described herein relate to a method of assembling an electrical connector, including: providing an inner housing, an outer housing, at least two terminals, and a PLR, positioning the PLR onto the inner housing; inserting in the outer housing, the inner housing with the PLR positioned onto it, up to a locked position where the inner housing is locked to the outer housing, inserting each terminal in the inner housing, up to a final position, where it is locked in the inner housing by primary locking means formed on the inner housing, and moving the PLR from an unlocking position, where it does not block the primary locking means, to a locking position, where it blocks the primary locking means and where a front sealing portion open on a mating side of the outer housing is cleared from the inner housing and the PLR.

The method of the preceding paragraph can optionally include, additionally and/or alternatively any, one or more of the following features, configurations and/or additional components.

In some aspects, the techniques described herein relate to a method 9, wherein the step of moving the PLR from the unlocking position to the locking position is performed with a tool engaging the PLR.

In some aspects, the techniques described herein relate to a method of removing a terminal from a connector having an inner housing including at least two cavities extending parallel to a longitudinal direction, an outer housing including a mating face and being configured to at least partially accommodate the inner housing, at least two terminals, each one of which being accommodated in one of the at least two cavities, and a primary lock reinforcement device (PLR), wherein the PLR is mounted on the inner housing and is configured to be moved, between the inner and outer housings, parallel to the longitudinal direction, between at least three positions: a locking position where the PLR is completely covered by the outer housing, where a front sealing portion open on the mating face of the outer housing is cleared from the inner housing and the PLR, and where the PLR provides a secondary locking means blocking primary locking means that locks each one of the at least two terminals, in a final position in its respective cavity, an intermediate position in which each one of the at least two terminals is locked by the primary locking means in the final position in its respective cavity, and an unlocking position where each one of the at least two terminals is released from the primary locking means, wherein the method includes: hooking the PLR with a tool and pulling the tool so as to move the PLR from its locking position and its unlocking position, thereby releasing each terminal.

In this document, the terms “front”, “rear”, “vertical”, “upwards”, “downwards”, “upper”, “top”, etc. and derivatives thereof refer to arbitrary orientations as shown on the drawings. However, it is to be understood that various alternative orientations may be used for illustrating this disclosure.

In the drawings and in the description, same reference numbers are used for the same or similar elements.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector, comprising:
an inner housing comprising at least two cavities extending parallel to a longitudinal direction;
an outer housing comprising a mating face and being configured to accommodate the inner housing at least partially;
at least two terminals, each one of which being accommodated in one of the at least two cavities; and
a primary lock reinforcement device (PLR), wherein the PLR is mounted on the inner housing and is configured to be moved, between the inner and outer housings, parallel to the longitudinal direction, between at least three positions:
a locking position where the PLR is completely covered by the outer housing, where a front sealing portion open on the mating face of the outer housing is cleared from the inner housing and the PLR, and where the PLR provides a secondary locking means blocking primary locking means that locks each one of the at least two terminals, in a final position in its respective cavity,
an intermediate position in which each one of the at least two terminals is locked by the primary locking means in the final position in its respective cavity, and
an unlocking position where each one of the at least two terminals is released from the primary locking means.

2. The electrical connector according to claim 1, wherein the inner housing has at least two latches, each one of these two latches being configured to form the primary locking means.

3. The electrical connector according to claim 2, wherein the PLR comprises at least two unlocking surfaces, each one of these two unlocking surfaces being configured to lift one of the at least two latches, when the PLR is moved from its locking position and to its unlocking position.

4. The electrical connector according to claim 3, wherein the PLR has an unlocking section comprising at least two unlocking wings, each one of these two unlocking wings bearing one of the at least two unlocking surfaces.

5. The electrical connector according to claim 4, wherein the PLR has an actuating leg extending longitudinally from a locking section toward the mating face, this actuating leg being configured to be accessible from the mating face.

6. The electrical connector according to claim 1, wherein the outer housing comprises the front sealing portion and a rear sealing portion, the outer housing being completely closed between the front sealing portion and the rear sealing portion, the inner housing and the PLR being both located behind the front sealing portion, with respect to the direction from the front sealing portion to the rear sealing portion, when the PLR is in its locking position.

7. A connector according to claim 1, wherein the PLR comprises a first hooking portion configured for actuating the PLR from the intermediate position to the locking position and vice-versa.

8. The connector according to claim 7, wherein the PLR comprises a second hooking portion configured for actuating the PLR from an intermediate position to its unlocking position and vice-versa.

9. A method of assembling an electrical connector, comprising:
providing an inner housing, an outer housing, at least two terminals, and a PLR;
positioning the PLR onto the inner housing;
inserting in the outer housing, the inner housing with the PLR positioned onto it, up to a locked position where the inner housing is locked to the outer housing;
inserting each terminal in the inner housing, up to a final position, where it is locked in the inner housing by primary locking means formed on the inner housing; and
moving the PLR from an unlocking position, where it does not block the primary locking means, to a locking position, where it blocks the primary locking means and where a front sealing portion open on a mating side of the outer housing is cleared from the inner housing and the PLR.

10. The method of according to claim 9, wherein the step of moving the PLR from the unlocking position to the locking position is performed with a tool engaging the PLR.

11. A method of removing a terminal from a connector having an inner housing comprising at least two cavities extending parallel to a longitudinal direction, an outer housing comprising a mating face and being configured to at least partially accommodate the inner housing, at least two terminals, each one of which being accommodated in one of the at least two cavities, and a primary lock reinforcement device (PLR), wherein the PLR is mounted on the inner housing and is configured to be moved, between the inner and outer housings, parallel to the longitudinal direction, between at least three positions: a locking position where the PLR is completely covered by the outer housing, where a front sealing portion open on the mating face of the outer housing is cleared from the inner housing and the PLR, and where the PLR provides a secondary locking means blocking primary locking means that locks each one of the at least two terminals, in a final position in its respective cavity, an intermediate position in which each one of the at least two terminals is locked by the primary locking means in the final position in its respective cavity, and an unlocking position where each one of the at least two terminals is released from the primary locking means, wherein the method comprises:
hooking the PLR with a tool and pulling the tool so as to move the PLR from its locking position and its unlocking position, thereby releasing each terminal.
